(19) United States
(12) Patent Application Publication
(10) Pub. No.: US 2019/0109355 A1
(43) Pub. Date: Apr. 11, 2019

(54) Battery Thermal Management Manifold Segment and Assembly Thereof

(71) Applicant: Norma U.S. Holding LLC, Auburn Hills, MI (US)

(72) Inventors: Carl Jones, Kimball, MI (US); Doug Fansler, Saint Clair, MI (US); Brian T. Ignaczak, Rochester, MI (US); Nicholas Ward, Port Huron, MI (US); Dave Peterson, Ortonville, MI (US); Michael R. Bucher, Clinton Township, MI (US)

(21) Appl. No.: 16/152,859

(22) Filed: Oct. 5, 2018

Related U.S. Application Data
(60) Provisional application No. 62/569,012, filed on Oct. 6, 2017.

(51) Int. Cl. H01M 10/6552; B60L 11/18; H01M 10/613; H01M 10/625

(52) U.S. Cl. CPC H01M 10/6552; B60L 11/187; H01M 2220/20; H01M 10/625; H01M 10/613

(57) ABSTRACT

A battery thermal management manifold segment is used amid the circulation of thermal management fluid to help regulate temperatures in a battery of an electric vehicle (EV). The battery thermal management manifold segment has one or more tubes—a feed tube, a return tube, or both—that have an inlet, an outlet, and a passage spanning therebetween. The tube(s) has one or more branch tubes extending therefrom. The branch tube(s) has a branch passage spanning from the passage of the tube(s).

### CROSS-REFERENCE TO RELATED APPLICATION

This application claims the benefit of U.S. Provisional Patent Application No. 62/569,012, filed Oct. 6, 2017.

### TECHNICAL FIELD

This disclosure relates generally to batteries in electric vehicles and, more particularly, to thermal management constructions for electric vehicle batteries.

### BACKGROUND

Electric vehicles (EVs), like hybrid electric vehicles (HEVs) and plug-in hybrid electric vehicles (PHEVs), employ batteries as a power source. Automotive electric vehicles, for instance, are increasingly using lithium-ion batteries as their power source. The batteries generate heat amid use and hence are typically equipped with thermal management constructions, such as cooling constructions, in order to regulate the temperature of the batteries. The thermal management constructions conventionally involve many lines and many connections among the lines and elsewhere. But the lines and connections can present unwanted occasions of fluid leakage and can bring about unwanted pressure drops thereacross, which could consequently hinder efficient battery performance.

### SUMMARY

In an embodiment, a battery thermal management manifold segment may include a feed tube, a return tube, and a crossmember. The feed tube has a feed inlet, a feed outlet, and a feed passage spanning between the feed inlet and feed outlet. The feed tube has multiple feed branch tubes. Each of the feed branch tubes has a feed branch passage that spans from the feed passage and fluidly communicates with the feed passage. The return tube has a return inlet, a return outlet, and a return passage spanning between the return inlet and return outlet. The return tube has multiple return branch tubes. Each of the return branch tubes has a return branch passage that spans from the return passage and fluidly communicates with the return passage. The crossmember extends between the feed tube and the return tube. Together, the feed tube, feed branch tubes, return tube, return branch tubes, and crossmember all constitute a monolithic construction of the battery thermal management manifold segment.

In an embodiment, the feed tube has one or more openings residing therein near an end for receipt of a retainer in order to establish a connection with an end of a second battery thermal management manifold segment.

In an embodiment, the end of the feed tube is a female inlet end. And the end of the second battery thermal management manifold segment is a male outlet end.

In an embodiment, the feed tube has a longitudinal clearance. The longitudinal clearance is defined between a first detent and a second detent. The longitudinal clearance receives a retainer in order to establish a connection with a second battery thermal management manifold segment.

In an embodiment, the longitudinal clearance is located near an end of the feed tube. The connection established with the second battery thermal management manifold segment is with an end of the second battery thermal management manifold segment.

In an embodiment, the first detent is an external first flange. And the second detent is an external second flange.

In an embodiment, a connection is established between the battery thermal management manifold segment and the second battery thermal management manifold segment when the retainer is received in the longitudinal clearance at a first longitudinal position. And a connection is established between the battery thermal management manifold segment and the second battery thermal management manifold segment when the retainer is received in the longitudinal clearance at a second longitudinal position that is spaced from the first longitudinal position.

In an embodiment, the crossmember has a section or more constructed to yield upon the occurrence of relative movement between the feed tube and the return tube.

In an embodiment, the monolithic construction of the battery thermal management manifold segment is effected by way of an injection molding process.

In an embodiment, the crossmember has a mounting engagement with a component of an electric vehicle battery.

In an embodiment, one or more of the feed branch tubes or return branch tubes establishes a connection with a component of an electric vehicle battery via a cartridge quick connector.

In an embodiment, a battery thermal management manifold assembly includes multiple battery thermal management manifold segments, as described above.

In another embodiment, a battery thermal management manifold segment may include a tube. The tube has an inlet, an outlet, and a passage that spans between the inlet and the outlet. The tube has one or more branch tubes that extend therefrom. The branch tube(s) has a branch passage that spans from the passage and that communicates therewith. The tube further has a longitudinal clearance that is defined between a first detent and a second detent for establishing a connection with a second battery thermal management manifold segment. The second battery thermal management manifold segment is a separate and discrete component from the battery thermal management manifold segment. The tube and the branch tube(s) constitute a monolithic construction of the battery thermal management manifold segment.

In an embodiment, the longitudinal clearance is located near an end of the tube.

In an embodiment, the first detent is an external first flange. And the second detent is an external second flange.

In an embodiment, the connection with the second battery thermal management manifold segment is established when the second battery thermal management manifold segment is at a first longitudinal position of the longitudinal clearance. And the connection with the second battery thermal management manifold segment is also established when the second battery thermal management manifold segment is at a second longitudinal position of the longitudinal clearance. The second longitudinal position is spaced from the first longitudinal position.

In an embodiment, a battery thermal management manifold assembly includes multiple battery thermal management manifold segments, as described above.

In yet another embodiment, a battery thermal management manifold segment may include a feed tube, a return tube, and a crossmember. The feed tube has a feed inlet, a feed outlet, and a feed passage that spans between the feed inlet and the feed outlet. The feed tube has one or more feed branch tubes that extend therefrom. The feed branch tube(s) has a feed branch passage that spans from the feed passage and that fluidly communicates therewith. The feed tube has a first longitudinal clearance that is defined between a first detent and a second detent in order to establish a connection with a second, discrete, battery thermal management manifold segment. The return tube has a return inlet, a return outlet, and a return passage that spans between the return inlet and the return outlet. The return tube has one or more return branch tubes that extend therefrom. The return branch tube(s) has a return branch passage that spans from the return passage and that fluidly communicates therewith. The return tube has a second longitudinal clearance that is defined between a third detent and a fourth detent in order to establish the connection with the second battery thermal management manifold segment. The crossmember extends between the feed tube and the return tube.

In an embodiment, the feed tube, feed branch tube(s), return tube, return branch tube(s), and crossmember all constitute a monolithic construction of the battery thermal management manifold segment.

In an embodiment, the connection with the second battery thermal management manifold segment is established when the second battery thermal management manifold segment is at a first longitudinal position of the first and second longitudinal clearances. And the connection with the second battery thermal management manifold segment is also established when the second battery thermal management manifold segment is at a second longitudinal position of the longitudinal clearance. The second longitudinal position is spaced from the first longitudinal position.

### BRIEF DESCRIPTION OF THE DRAWINGS

Embodiments of the disclosure are described with reference to the appended drawings, in which:

FIG. 1 is a perspective view of an embodiment of a battery thermal management manifold segment;

FIG. 2 is another perspective view of the battery thermal management manifold segment of FIG. 1;

FIG. 3 is a top view of the battery thermal management manifold segment of FIG. 1;

FIG. 4 is a front view of the battery thermal management manifold segment of FIG. 1;

FIG. 5 is a rear view of the battery thermal management manifold segment of FIG. 1;

FIG. 6 is a sectional view of the battery thermal management manifold segment of FIG. 1;

FIG. 7 is a perspective view of an embodiment of a cartridge quick connector that can be used with the battery thermal management manifold segment of FIG. 1;

FIG. 8 is a sectional view of the cartridge quick connector of FIG. 7;

FIG. 9 is a sectional view of the cartridge quick connector of FIG. 7; and

FIG. 10 is a sectional view of the cartridge quick connector of FIG. 7.

### DETAILED DESCRIPTION

Referring to the drawings, an embodiment of a battery thermal management manifold segment (hereafter “battery manifold segment”) is depicted that is used amid the circulation of thermal management fluid to help regulate temperatures in a battery of an electric vehicle (EV). In example applications, the thermal management fluid is coolant and the battery is a lithium-ion battery employed as a power source in the EV. The phrase “electric vehicle” and its abbreviation and grammatical variations is used broadly herein to encompass hybrid electric vehicles (HEVs), plug-in electric vehicles (PHEVs), and other types of electric vehicles in automotive applications like cars and trucks, as well as in non-automotive applications like busses, motorcycles, and boats. The battery manifold segment is designed and constructed as a modular component whereby multiple segments can be adjoined in serial and tandem arrangement to set up a battery thermal management manifold assembly—in this regard, a single battery manifold segment constitutes a unit of a larger assembly of units in application. Among other advancements, the battery manifold segment has a minimal number of discrete lines and connections and hence reduces the occasions for fluid leakage compared to previously-known thermal management constructions equipped in EV batteries. In like manner, the battery manifold segment optimizes fluid flow performance and hence reduces pressure drop thereacross compared to the previously-known constructions. Furthermore, unless otherwise specified, the terms radially, axially, and circumferentially, and their grammatical variations, refer to directions with respect to the generally cylindrical shape of tubes of the battery manifold segment.

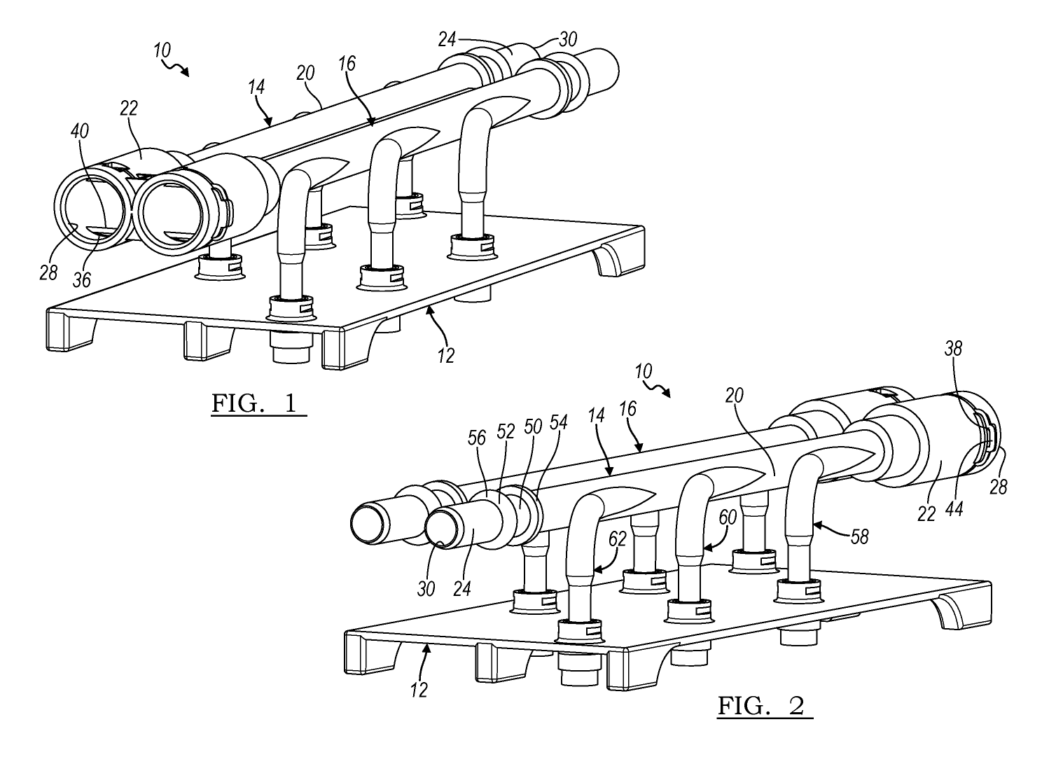

FIGS. 1-6 present an embodiment of a battery manifold segment 10. In an example application, coolant travels through the battery manifold segment 10 as the coolant makes its way to various locations in an EV lithium-ion battery for purposes of temperature regulation. The battery manifold segment 10 can itself be installed at various locations in an EV lithium-ion battery and can be mounted to various components, depending on the particular application. In the example of the figures, the battery manifold segment 10 is mounted to a battery tray 12. The exact quantity of battery manifold segments in a given application—and hence the number adjoined together to make up a battery thermal management assembly—can be driven by the construction and components of the associated battery such as the amount and measure of battery cells. In the example application, there can be a total of four battery manifold segments in the battery thermal management assembly.

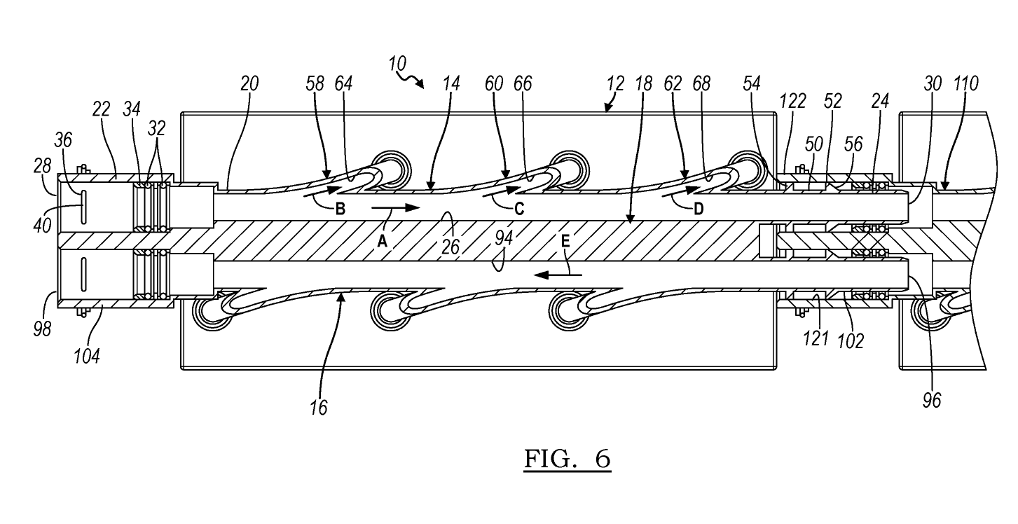

The battery manifold segment 10 can have different designs and constructions and components in different embodiments, which in some cases are dictated by the construction and components of the associated battery and the particular application. In the embodiment of FIGS. 1-6, the battery manifold segment 10 has a pair of tubes 14, 16 and a crossmember 18 extending between the tubes 14, 16. The pair of tubes are a feed tube 14 and a return tube 16. Coolant travels through the feed tube 14 as the coolant is delivered to the EV lithium-ion battery. The feed tube 14 has a main body 20 that extends between a feed inlet end 22 and a feed outlet end 24. The main body 20 defines a feed passage 26 that spans axially and without turns between a feed inlet 28 and a feed outlet 30. Referring in particular to FIG. 6, coolant travels along a direction A through the feed passage 26.

To establish connections among discrete battery manifold segments in tandem arrangement, the feed inlet and outlet ends 22, 24 are furnished with complementary members that join together with quick-connect functionality for ready connection and disconnection. The quick-connect functionality can be effected in various ways. In the embodiment of the figures, the quick-connect functionality is carried out in a telescopically overlapping manner involving male and female ends and a retainer, as described below. Moreover, to accommodate manufacturing tolerances and variations among discrete battery manifold segments in tandem arrangement, the feed inlet and outlet ends 22, 24 are furnished with measures and means to establish a connection when the battery manifold segments exhibit different relative longitudinal positions and different relative extents of overlap among the male and female ends. The manufacturing tolerances and variations accumulate with the number of adjoined battery manifold segments. The measures and means can also accommodate longitudinal movement among discrete battery manifold segments in tandem arrangement. These accommodations can be effected in various ways. In the embodiment of the figures, the accommodations are carried out via the telescopically overlapping manner and receipt of the retainer within a longitudinal clearance, as described below.

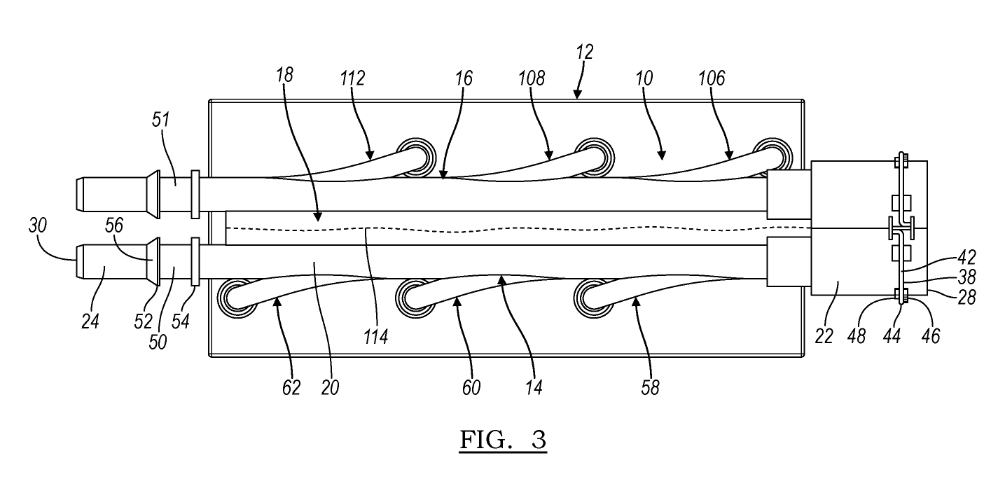

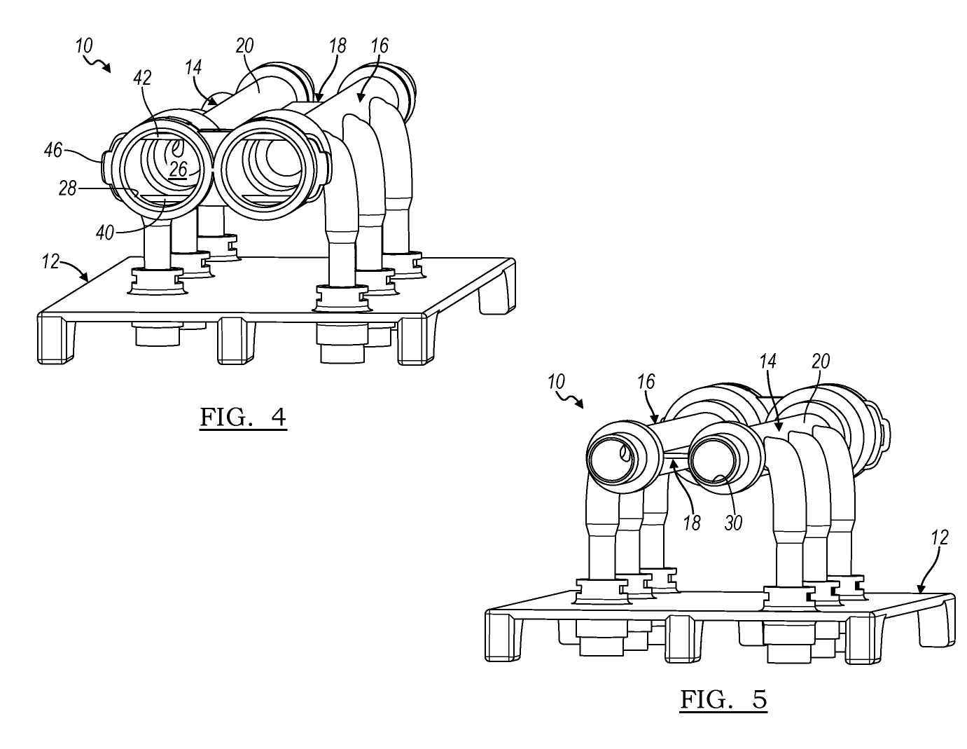

Referring now to FIGS. 3 and 6, the feed inlet end 22 is designed and constructed as a female end form and the feed outlet end 24 is designed and constructed as a male end form, although these forms could be reversed in other embodiments. When battery manifold segments are arranged together, and referring particularly to FIG. 6, the male feed outlet end 24 is inserted into and received by a second female inlet end 122 of a discrete second battery manifold segment 110. The feed inlet end 22 has a diametrically-increased section relative to the feed passage 26 for receipt of a male feed outlet end. In the embodiment here, a pair of O-rings 32 and a bushing 34 are seated within the feed inlet end 22. A first and second opening 36 (only one opening shown in FIG. 6) reside in, and are defined through, the main body 20 at the feed inlet end 22. The first and second openings 36 each receive a leg 40, 42 of a retainer 38. As perhaps demonstrated best in FIG. 4, the legs 40, 42 pass-through the first and second openings 36 inside of the feed passage 26 for interaction with the complementary quick-connect member of the male feed outlet end, as subsequently described. In the embodiment here, and referring now to FIGS. 1, 3, and 4, the retainer 38 is a one-piece stainless-steel wire spring with the legs 40, 42 biased inwardly toward each other and with a bridge 44 extending between the legs 40, 42. The legs 40, 42 are substantially similar in size and shape. In assembly and use, the retainer 38 is carried by the feed inlet end 22 with its legs 40, 42 received through the first and second openings 36 where portions of the legs 40, 42 are suspended within the feed passage 26. The bridge 44 remains at an exterior of the feed inlet end 22 and is disposed between a first protrusion 46 and a second protrusion 48. The first protrusion 46 juts radially-outwardly farther than the second protrusion 48, whereby the first protrusion 46 helps prevent inadvertent dislodging of the bridge 44 and thus dislodging of the retainer 38 therefrom, while the second protrusion 48 permits external access of the bridge 44 by a user.

The feed outlet end 24 is formed as a spigot for insertion into the second female inlet end 122 of the discrete second battery manifold segment 110. Referring now to FIGS. 2, 3, and 6, for interaction with the legs 40, 42 of the retainer 38, a longitudinal clearance 50 is defined between a first detent 52 and a second detent 54. The longitudinal clearance 50 is a cylindrical spacing having an axial length measured between the first and second detents 52, 54. The exact axial length of the longitudinal clearance 50 can be selected based on an anticipated or desired amount of longitudinal accommodation in the particular battery thermal management assembly. In one example, the axial length of the longitudinal clearance 50 can be approximately twelve millimeters (12 mm), but of course other dimensions are possible in other examples. A connection between tandemly-arranged battery manifold segments is established when the legs 40, 42 of the retainer 38 pass-through the first and second openings 36 and are received within the longitudinal clearance 50. The longitudinal clearance 50 can take different forms in other embodiments, such as by being defined within an inset groove residing in the wall of the main body 20. The first detent 52 and the second detent 54 are in the form of a first flange 52 and a second flange 54 in the embodiment of the figures. The first and second flanges 52, 54 are ring-like structures projecting radially-outwardly from the main body 20. The first flange 52 is set back an axial distance from a terminal end of the feed outlet end 24, and the second flange 54 is spaced axially from the first flange 52 farther from the terminal end. The first flange 52 has a ramped surface 56 at its forward end so that the legs 40, 42 can ride up over the first flange 52 and into the longitudinal clearance 50 upon entry of the feed outlet end 24 into the second female inlet end 122. Once within the longitudinal clearance 50, the first and second flanges 52, 54 serve to arrest movement of the legs 40, 42 passed the flanges 52, 54 and out of the clearance 50. Moreover, with both of the first and second flanges 52, 54 inserted into the second female inlet end 122, interfering engagement and direct abutment between the flanges 52, 54 and an interior surface 121 of the second female inlet end 122 preclude off-axis movement between the battery manifold segment 10 and the second battery manifold segment 110 when subjected to side-loading exertions.

The longitudinal clearance 50 is part of the measures and means that accommodate manufacturing tolerances and variations and longitudinal movements. The longitudinal clearance 50 has an axial length that accepts receipt of the legs 40, 42 at different longitudinal positions across the longitudinal clearance 50, while still establishing an effective connection between tandemly-arranged battery manifold segments. For example, a connection is established when the legs 40, 42 are received within the longitudinal clearance 50 at a first longitudinal position therein, which may be an axial midpoint of the longitudinal clearance 50. And a connection is established yet again when the legs 40, 42 are received within the longitudinal clearance 50 at a second longitudinal position therein, which may be spaced an axial distance to either side of the axial midpoint. In this way, these interactions between the retainer 38 and the longitudinal clearance 50 impart an amount of axial adjustability in the established connection between tandemly-arranged battery manifold segments that accounts for accumulated manufacturing tolerances and variations and for longitudinal movements brought about in the battery thermal management assembly. Male and female ends of battery manifold segments hence need not necessarily have full and entirely consistent extents of overlap between them to establish an effective connection thereat, and instead could have varying degrees of overlap for connection.

Further, the feed tube 14 has multiple feed branch tubes extending from the main body 20 to deliver distributed amounts of coolant to the EV lithium-ion battery. Referring to FIGS. 2, 3, and 6, in this embodiment the feed tube 14 has three feed branch tubes: a first feed branch tube 58, a second feed branch tube 60, and a third feed branch tube 62. Other quantities of feed branch tubes are possible, such as more or less than three. The feed branch tubes 58, 60, 62 are appendages of the feed tube 14 that are bent downwardly therefrom, and are spaced longitudinally from one another. Each feed branch tube 58, 60, 62 defines a feed branch passage spanning from the feed passage 26—namely, a first feed branch passage 64, a second feed branch passage 66, and a third feed branch passage 68. The feed branch passages 64, 66, 68 fluidly communicate with the feed passage 26 such that coolant travels along paths B, C, and D through the feed branch passages 64, 66, 68.

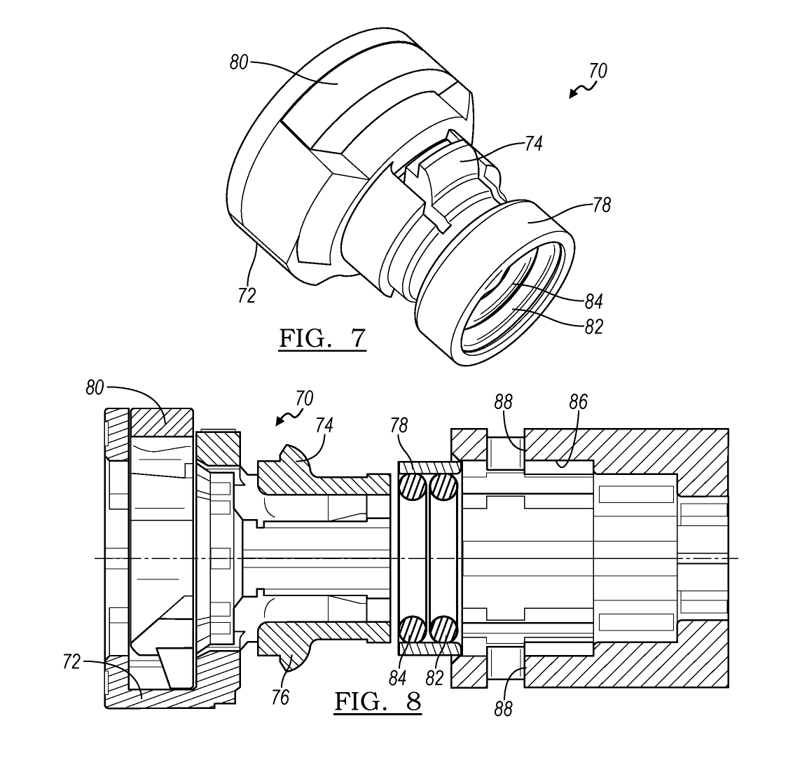

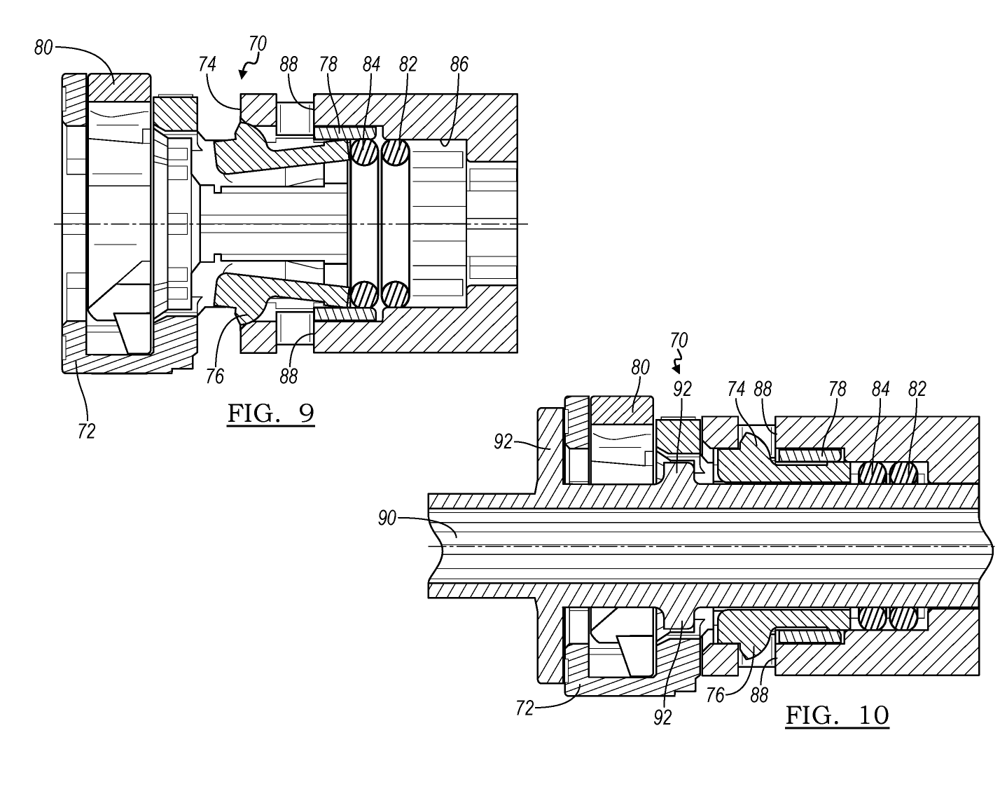

The feed branch tubes 58, 60, 62 can make connections with the battery tray 12 in various ways. In one example, distal ends of the feed branch tubes 58, 60, 62 can be formed as spigots that are inserted and molded into complementary formations of the battery tray 12. In another example, and referring now to FIGS. 7-10, the connection between the feed branch tubes 58, 60, 62 and the battery tray 12 can be made via a cartridge quick connector 70. In the embodiment presented by FIGS. 7-10, the cartridge quick connector 70 has a body 72, a pair of clips 74, 76, a sleeve 78, a retainer 80, and a pair of O-rings 82, 84. In installation, the battery tray 12 can have a cavity formation 86 with varying diameter dimensions and with recesses 88 for receiving the clips 74, 76. The distal ends of the feed branch tubes 58, 60, 62, on the other hand, can be formed as spigots 90 with one or more flanges 92 that cooperate with the cartridge quick connector 70 upon full insertion, as depicted in FIG. 10. Referring to FIG. 8, in a first state of installation, the cartridge quick connector 70 is brought in-line with the cavity formation 86. Referring to FIG. 9, in a second state of installation, the cartridge quick connector 70 is inserted partway into the cavity formation 86. The sleeve 78 slides rearward due to engagement with a wall of the cavity formation 86 as the pair of O-rings 82, 84 proceed forward inside of the cavity formation 86. Concurrently, the clips 74, 76 flex inward as they yield to engagement with a wall of the cavity formation 86. And referring to FIG. 10, in a third and final state of installation, the cartridge quick connector 70 is fully inserted into the cavity formation 86. The sleeve 78 is slid farther rearward and the pair of O-rings 82, 84 proceed farther forward. The clips 74, 76 have sprung outward for receipt into the recesses 88. The spigot 90 is inserted through the cartridge quick connector 70 and within the cavity formation 86. The retainer 80 holds the spigot 90 therein by way of interfering abutment with one of the flanges 92.

As demonstrated in FIGS. 1-6, the return tube 16 has a similar design and construction as the feed tube 14, and thus the description of the return tube 16 is provided here in a somewhat abbreviated form. The return tube 16 has a return passage 94 that spans between a return inlet 96 and a return outlet 98. Coolant travels along a direction E through the return passage 94. Return inlet and outlet ends 102, 104 are similarly furnished with quick-connect functionalities, as previously described, and with accommodations for manufacturing tolerances and variations and for longitudinal movements, as previously described. The return tube 16, like the feed tube 14, has a longitudinal clearance 51. The return tube 16 has a first return branch tube 106, a second return branch tube 108, and a third return branch tube 112. As before, each return branch tube 106, 108, 112 defines a return branch passage spanning from the return passage 94. And as before, the return branch tubes 106, 108, 112 can make connections with the battery tray 12 via the cartridge quick connector 70, or via another way.

Referring now to FIG. 3, in this embodiment the crossmember 18 serves as a unitary extension and attachment between the feed tube 14 and the return tube 16. The crossmember 18 can have different forms in different embodiments. In the embodiment of the figures, the crossmember 18 is in the form of a single-piece and planar intermediate wall extending transversely between the feed and return tubes 14, 16. In an exemplary injection molding manufacturing process, the crossmember 18 facilitates molding the battery manifold segment 10 as a whole and single unit. Furthermore, the crossmember 18 can be used for placement of the battery manifold segment 10 with respect to the battery tray 12, and thus the crossmember 18 could have a mounting engagement with the battery tray 12. The mounting engagement could be effected in various ways in different embodiments; for example, the mounting engagement could involve a structural extension spanning from the crossmember 18 and coming into engagement with a complementary structural component of the battery tray 12 amid placement or with another component. Further, a section or more of the crossmember 18 could be hinged, perforated, or have some other functionally-similar construction, that enables the crossmember to bend and yield to exertions that cause relative movement between the feed tube 14 and the return tube 16 without unwanted fracture of the crossmember 18; in this regard, the crossmember 18 could furnish accommodations for such exertions and relative movement. The section or more of the crossmember 18 that could be hinged, perforated, or have some other functionally-similar construction is, in general, represented in FIG. 3 by broken line 114.

The battery manifold segment 10 can be manufactured by various manufacturing processes. In an example, the battery manifold segment 10 is composed of a plastic material and is manufactured by way of an injection molding operation such as a gas-assisted or water-assisted injection molding process. Such an injection molding process produces the battery manifold segment 10 in a monolithic construction in which all of its primary components—the feed tube 14, the return tube 16, and the crossmember 18—are formed as one-piece. Because they are formed as one-piece, the number of discrete lines and connections is minimized compared to previously-known thermal management constructions, and therefore the occasions for fluid leakage is substantially reduced. For example, discrete connections are absent among the feed tube 14 and its feed branch passages 64, 66, 68, and discrete connections are absent among the return tube 16 and its return branch tubes 106, 108, 112. In like manner, fluid flow performance is optimized and pressure drop is not as severe among the feed tube 14 and its feed branch passages 64, 66, 68 and among the return tube 16 and its return branch tubes 106, 108, 112.

In other embodiments not illustrated in the figures, the battery manifold segment could have different designs and constructions and components. In one example, the battery manifold segment need not have the crossmember, and instead could be made up of a single tube, such as a single feed tube or a single return tube, with one or more branch tubes, as but one example of an embodiment lacking the crossmember. In another example, the quick-connect functionality at the ends of the tubes need not be provided. In yet another example, the accommodations for manufacturing tolerances and variations and for longitudinal movement need not be provided.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A battery thermal management manifold segment, comprising:
a feed tube having a feed inlet, a feed outlet, and a feed passage spanning between said feed inlet and said feed outlet, said feed tube having a plurality of feed branch tubes extending therefrom, each of said plurality of feed branch tubes having a feed branch passage spanning from said feed passage and fluidly communicating therewith;
a return tube having a return inlet, a return outlet, and a return passage spanning between said return inlet and said return outlet, said return tube having a plurality of return branch tubes extending therefrom, each of said plurality of return branch tubes having a return branch passage spanning from said return passage and fluidly communicating therewith; and
a crossmember extending between said feed tube and said return tube;
wherein said feed tube, said plurality of feed branch tubes, said return tube, said plurality of return branch tubes, and said crossmember all constitute a monolithic construction of the battery thermal management manifold segment.

2. The battery thermal management manifold segment set forth in claim 1, wherein said feed tube has at least one opening residing therein adjacent an end for receipt of a retainer to establish a connection with an end of a second battery thermal management manifold segment.

3. The battery thermal management manifold segment set forth in claim 2, wherein said end of said feed tube is a female inlet end and the end of the second battery thermal management manifold segment is a male outlet end.

4. The battery thermal management manifold segment set forth in claim 1, wherein said feed tube has a longitudinal clearance defined between a first detent and a second detent for receipt of a retainer to establish a connection with a second battery thermal management manifold segment.

5. The battery thermal management manifold segment set forth in claim 4, wherein said longitudinal clearance is located adjacent an end of said feed tube, and the connection established with the second battery thermal management manifold segment is with an end of the second battery thermal management manifold segment.

6. The battery thermal management manifold segment as set forth in claim 4, wherein said first detent is an external first flange and said second detent is an external second flange.

7. The battery thermal management manifold segment as set forth in claim 4, wherein a connection is established between the battery thermal management manifold segment and the second battery thermal management manifold segment when the retainer is received in said longitudinal clearance at a first longitudinal position, and a connection is established between the battery thermal management manifold segment and the second battery thermal management manifold segment when the retainer is received in said longitudinal clearance at a second longitudinal position that is spaced from said first longitudinal position.

8. The battery thermal management manifold segment as set forth in claim 1, wherein said crossmember has at least a section constructed to yield upon occurrence of relative movement between said feed tube and said return tube.

9. The battery thermal management manifold segment as set forth in claim 1, wherein the monolithic construction of the battery thermal management manifold segment is effected via an injection molding process.

10. The battery thermal management manifold segment as set forth in claim 1, wherein said crossmember has a mounting engagement with a component of an electric vehicle battery.

11. The battery thermal management manifold segment as set forth in claim 1, wherein at least one of said plurality of feed branch tubes or return branch tubes establishes a connection with a component of an electric vehicle battery via a cartridge quick connector.

12. A battery thermal management manifold assembly comprising a plurality of battery thermal management manifold segments as set forth in claim 1.

13. A battery thermal management manifold segment, comprising:
a tube having an inlet, an outlet, and a passage spanning between said inlet and said outlet, said tube having at least one branch tube extending therefrom, said at least one branch tube having a branch passage spanning from said passage and communicating therewith, said tube further having a longitudinal clearance defined between a first detent and a second detent for establishment of a connection with a second, discrete, battery thermal management manifold segment;
wherein said tube and said at least one branch tube constitute a monolithic construction of the battery thermal management manifold segment.

14. The battery thermal management manifold segment set forth in claim 13, wherein said longitudinal clearance is located adjacent an end of said tube.

15. The battery thermal management manifold segment set forth in claim 13, wherein said first detent is an external first flange and said second detent is an external second flange.

16. The battery thermal management manifold segment set forth in claim 13, wherein the connection with the second battery thermal management manifold segment is established when the second battery thermal management manifold segment is at a first longitudinal position of the longitudinal clearance, and the connection with the second battery thermal management manifold segment is also established when the second battery thermal management manifold segment is at a second longitudinal position of the longitudinal clearance, the second longitudinal position being spaced from the first longitudinal position.

17. A battery thermal management manifold assembly comprising a plurality of battery thermal management manifold segments as set forth in claim 13.

18. A battery thermal management manifold segment, comprising:
a feed tube having a feed inlet, a feed outlet, and a feed passage spanning between said feed inlet and said feed outlet, said feed tube having at least one feed branch tube extending therefrom, said at least one feed branch tube having a feed branch passage spanning from said feed passage and fluidly communicating therewith, said feed tube having a first longitudinal clearance defined between a first detent and a second detent for establishment of a connection with a second, discrete, battery thermal management manifold segment;
a return tube having a return inlet, a return outlet, and a return passage spanning between said return inlet and said return outlet, said return tube having at least one return branch tube extending therefrom, said at least one return branch tube having a return branch passage spanning from said return passage and fluidly communicating therewith, said return tube having a second longitudinal clearance defined between a third detent and a fourth detent for establishment of the connection with the second battery thermal management manifold segment; and
a crossmember extending between said feed tube and said return tube.

19. The battery thermal management manifold segment set forth in claim 18, wherein said feed tube, said at least one feed branch tube, said return tube, said at least one return branch tube, and said crossmember all constitute a monolithic construction of the battery thermal management manifold segment.

20. The battery thermal management manifold segment set forth in claim 18, wherein the connection with the second battery thermal management manifold segment is established when the second battery thermal management manifold segment is at a first longitudinal position of the first and second longitudinal clearances, and the connection with the second battery thermal management manifold segment is also established when the second battery thermal management manifold segment is at a second longitudinal position of the first and second longitudinal clearances, the second longitudinal position being spaced from the first longitudinal position.
